(19) United States
(12) Patent Application Publication
(10) Pub. No.: US 2020/0226543 A1
(43) Pub. Date: Jul. 16, 2020

(54) RETAIL SELF-STORAGE SOLUTION

(71) Applicant: BOX DOCK, LLC, Lake Success, NY (US)

(72) Inventor: Marc Sharinn, Lake Success, NY (US)

(21) Appl. No.: 16/739,479

(22) Filed: Jan. 10, 2020

Related U.S. Application Data
(60) Provisional application No. 62/790,913, filed on Jan. 10, 2019.

(51) Int. Cl. G06Q 10/08; G06Q 10/06

(52) U.S. Cl. CPC G06Q 10/0836; G06K 19/06037; G06Q 10/06315

(57) ABSTRACT

A method for depositing items into a storage facility includes receiving a request for storing an item, providing information descriptive of the item. The information is received from the user. A vehicle type that is adapted to transport the first item is determined based on the information received from the user. A first location, where the first item is available for pickup, is determined. A storage facility for storing the first item is determined. The storage facility is associated with a physical address, and the physical address of the storage facility corresponds to a second location. A vehicle that matches the determined vehicle type is dispatched to the first location with instructions for picking up the first item and delivering the first item to the second location such that the first item can be stored at the storage facility.

### CROSS-REFERENCE TO RELATED APPLICATION

This application claims priority to U.S. Provisional Patent Application No. 62/790,913, filed on Jan. 10, 2019, the disclosure of which is incorporated by reference herein in its entirety.

### FIELD OF THE INVENTION

The present invention relates to a storage device, system and method, and more particularly, to a self-storage device, system and method that can be used to facilitate the process of storing items in a remote storage location as well as retrieving the items from the remote storage location.

### BACKGROUND OF THE INVENTION

Currently, storage options available for both personal and business use are self-storage and valet storage.

Self-storage, the more traditional approach, offers individual storage spaces within a building(s) that are commonly rented on a square footage or cubic footage basis. In many cases, self-storage spaces are rented for a desired length of time and vacated once use of the storage space is no longer necessary.

Valet storage is a service that is initiated by contacting a valet storage company. Once contacted, the valet storage company will quote a “unit size” to the customer, and rent will be determined and agreed upon based on the term of the rental and unit size. An appointment will be scheduled and the valet service will send one or more individuals to retrieve storage items from the customer. The expense of the convenience of not having to transport items to the storage location is passed on to the customer. The items are then moved within warehouses owned by the valet company and stored for the period of time agreed upon. Either upon customer request or at the completion of a contract, items are then delivered back to the customers. Items are inaccessible until a request is made or the contract between the customer and company ends. At this time, the valet company will transport the customer's items from the warehouse(s) back to the customer. There is commonly a further expense for this service that is passed on to the customer.

Accordingly, there is a need for a cost-efficient and convenient self-storage device, system and method.

### SUMMARY OF THE INVENTION

The present disclosure is directed to a valet self-storage system, device and method that addresses the deficiencies of past storage options. The valet self-storage model uses kiosks that are dispersed throughout a retail area, commercial area, or residential area. For example, the self-storage kiosks can be dispersed in stores and/or in residential buildings in prominent and/or easily accessible locations. These kiosks and hub locations are supported by warehouses, which function as deep storage facilities and provide storage on a micro-warehousing basis.

A user needing to store items engages with the kiosk's computer system to create an account, if needed, and then will log into the kiosk's computer system. Once logged in, the user can add items to be stored, such as by selecting from a pre-populated list, to his/her account via the kiosk. The kiosk then prompts the user to affix QR inventory bar codes (or other types of computer readable indicia) that the kiosk prints to each corresponding item. The kiosk is also configured to obtain images of each item (with or without the inventory bar code displayed next to the item or superimposed over the item) with an oriented camera to validate/verify that the user's description of the items matches the items, and for other record purposes such as associating the stored items with the customer/customer account.

An authorized employee or other authorized person can then secure the user's item(s) until the items are pick up by an appropriate vehicle, such as car, van, truck, etc. When the vehicle's driver arrives at the location of the kiosk, the driver collects the user's item(s) and transports them to a storage warehouse.

Users can also retrieve their stored items by requesting a delivery of stored items. Items can be requested separately, in defined groups, or in their entirety. The requested items can be delivered to a kiosk location, or to another address requested by the user.

According to an exemplary embodiment of the present invention, a method for depositing a user's items into a storage facility includes receiving the user's request for storing a first item. The user is prompted to provide information descriptive of the first item and the system receives the requested information from the user. A vehicle type appropriate to transport the first item is determined based on the item information received from the user. A first location, where the first item is available for pickup, is determined. An appropriate storage facility for storing the first item is determined. The storage facility is associated with a physical address, and the physical address of the storage facility is associated with a second location. A vehicle that matches the determined vehicle type is dispatched to the first location with instructions for picking up the first item and delivering the first item to the second location.

According to an exemplary embodiment of the present invention, a storage system includes a processor and a non-transitory, tangible, program storage medium, readable by the storage system, embodying a program of instructions executable by the processor to perform method steps for depositing a user's items into a storage facility. The method includes receiving the user's request for storing a first item. The user is requested to provide information that describes the first item. The information is received from the user. A vehicle type that is adapted to transport the first item is determined based on the information received from the user. A first location, where the first item is available for pickup, is determined. A storage facility for storing the first item is determined. The storage facility is associated with a physical address, and the physical address of the storage facility is associated with a second location. A vehicle that matches the determined vehicle type is dispatched to the first location with instructions for picking up the first item and delivering the first item to the second location.

### BRIEF DESCRIPTION OF THE DRAWINGS

The above and other features of the present invention will become more apparent by describing in detail exemplary embodiments thereof in conjunction with the accompanying drawings, in which:

FIG. 1 is a diagram of a system for depositing and retrieving items from a storage facility according to an embodiment of the present disclosure;

FIG. 2 is a flowchart illustrating the method steps of a program of instructions executable by a processor to perform method steps for depositing a user's items into a storage facility according to an embodiment of the present disclosure;

FIG. 3 is a flowchart illustrating steps of the method for placing items into storage according to an embodiment of the present disclosure;

FIG. 4 is a map indicating an exemplary retail location which a customer can utilize for dropping off personal items that need to be placed in storage, and a location for picking up items that are retrieved from storage, according to an embodiment of the present disclosure;

FIGS. 5A through 5D are various views of a kiosk according to an embodiment of the present disclosure;

FIG. 5E is a perspective view of a kiosk according to an embodiment of the present disclosure;

FIG. 6 is a plan view of an exemplary retail location, according to an embodiment of the present disclosure;

FIG. 7A illustrates a plurality of bins that can be used to transport/store items according to an embodiment of the present disclosure;

FIG. 7B illustrates a garment bag that can be used to transport/store items according to an embodiment of the present disclosure;

FIG. 7C illustrates a ski bag that can be used to transport/store items according to an embodiment of the present disclosure;

FIG. 7D illustrates a duffel bag that can be used to transport/store items according to an embodiment of the present disclosure;

FIGS. 8A through 8S illustrate exemplary screen shots of a display panel of a kiosk when a user performs the method steps depicted in FIGS. 2 and 3, according to an embodiment of the present disclosure;

FIG. 9 illustrates a representative warehouse hierarchical chart according to an embodiment of the present disclosure;

FIG. 10 illustrates a method of matching a pickup request from a kiosk for delivery to a warehouse according to an embodiment of the present disclosure;

FIG. 11 illustrates a method of retrieving items from a warehouse for delivery to a kiosk according to an embodiment of the present disclosure;

FIG. 12 illustrates a method for delivering items from an indicated address to a retail location according to an embodiment of the present disclosure; and

FIG. 13 illustrates a method for delivering items from an indicated address to a retail location according to an embodiment of the present disclosure.

### DETAILED DESCRIPTION OF EMBODIMENTS OF THE PRESENT INVENTION

Exemplary embodiments of the present invention will be described more fully hereinafter with reference to accompanying drawings. The present invention may, however, be embodied in different forms and should not be construed as limited to the embodiments set forth herein.

The present disclosure is directed generally to a brick-and-mortar-based storage solution with single item pricing. The storage solution of the present invention provides readily available, on demand transportation of items into and out of a storage facility by using local brick-and-mortar facilities as intermediary locations. The brick-and-mortar facilities may also be referred to as retail locations. A user can drop off one or more individual items for storage into a retail location. A vehicle suitable for transporting item(s) to a storage location such as a warehouse will be dispatched to the retail location for picking up the item(s) and transporting the item(s) to a suitable storage location.

A request can be made to retrieve any individual item from the storage location by, for example, visiting a retail location and engaging with a kiosk disposed in the retail location. The requested item will be retrieved from storage and can be delivered, for example, to the retail location or to another location requested by the customer.

Additionally, or alternatively, a request to retrieve any individual item from the storage location by using a personal device, for example, a personal computer (PC), a tablet PC, a smartphone, etc., allowing retrieval requests to be issued from a location convenient to the user, such as his/her current location, home address, etc., in order to avoid the trip a kiosk.

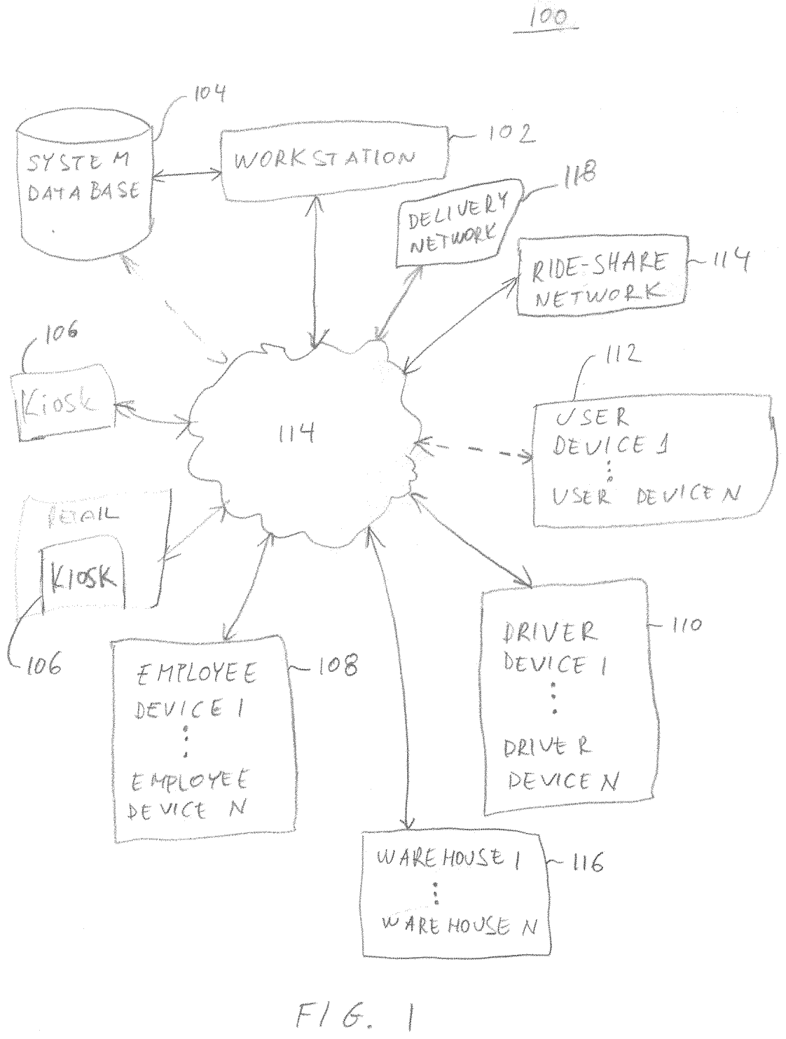

FIG. 1 is a schematic diagram of a system 100 for depositing and retrieving items from a storage facility according to an embodiment of the present disclosure.

Referring to FIG. 1, the system 100 may include a workstation 102, a system database 104, a plurality of kiosks 106, a plurality of employee devices 108, a plurality of driver devices 110 a plurality of user devices 112 and a plurality of warehouses 116. The workstation 102 may also be connected to a ride-share network 114 for hiring/renting vehicles with a driver on a need-basis. In addition, the workstation 102 may be connected to a delivery network 118 for utilizing delivery persons/concierge for transporting a user's items when needed.

The system database 104 may be connected to the workstation directly or through the Internet.

The workstation 102 may be a workstation, a server, or other type of a computer with a high processing power. The workstation 102 is programed to operate as disclosed herein and has access to the system database 104 for storing various types of information including user account, item storage data and status, 1D or 2D bar codes, delivery vehicle information, driver information, etc.

The workstation 102 can be a single or distributed device and, the database can be in a memory local to the workstation, a remote cloud storage, or a combination. The workstation 102 may also have access to various third-party systems, such as mapping, weather, and traffic applications.

The workstation 102 memory includes computer software for performing the various functions described herein, including receiving requests for placing items in storage, for identifying appropriate vehicle(s) and assigning pickup and delivery routes, and other coordination of the delivery of and retrieval of items to and from storage and retail locations.

The workstation 102 is connected to a network, such as the internet, and can be accessed by the kiosks 106 and other computing devices such as a user's devices 112.

The user devices 112 and the driver devices 112 may include one or more of a PC, laptop computer, tablet PC, smartphone, etc. At least some of the employee devices 108 and some of the user devices 110 is equipped with printing and/or scanning functionality.

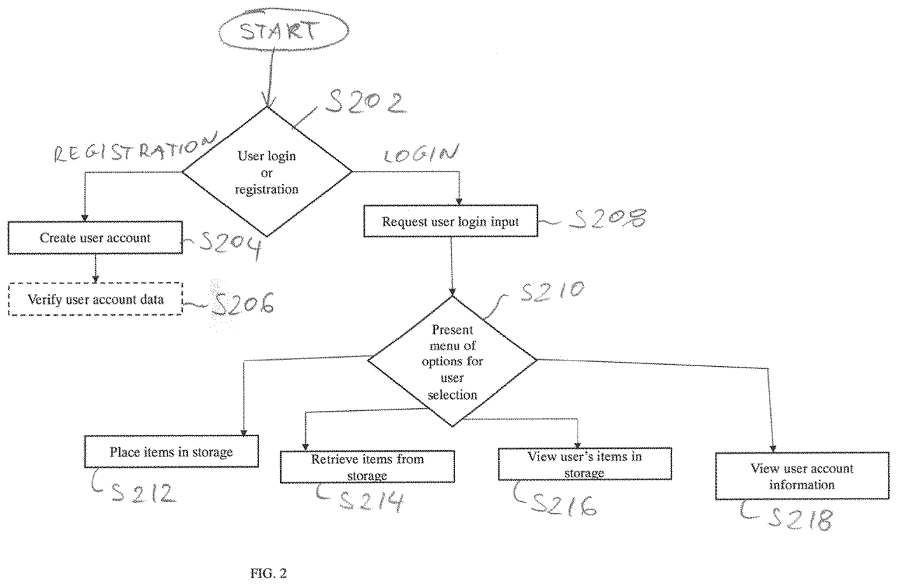

FIG. 2 is a high level flowchart illustrating the method steps of a program of instructions (or software) executable by a processor to perform method steps for depositing a user's items into a storage facility according to an embodiment of the present disclosure. The system software may be executed by the processor of the workstation 102 and/or remotely by using the processor included in any one of the kiosks 106, the employee devices 108, driver devices 110, and user devices 112.

Referring to FIG. 2, a user may be asked to login or to register by creating a new account (Step S202). When a user is not registered, he/she may elect to create a new account and may be asked for relevant information such as name, last name, address, telephone number, address, billing information such as credit card and/or bank account information, etc. (Step S204). The user's identity and billing info may be verified for accuracy (Step S206).

After a user has created an account, the user may be requested to input his/her login information (Step S208). After successful login, the user is presented with a menu of available options for selection (Step S210). The options may include, for example, requesting to place one or more items in storage (Step S212), requesting to retrieve one or more items from storage (Step S214), requesting to view an inventory of the user's items in storage (Step S216), requesting to review the user's account information (Step S218), etc.

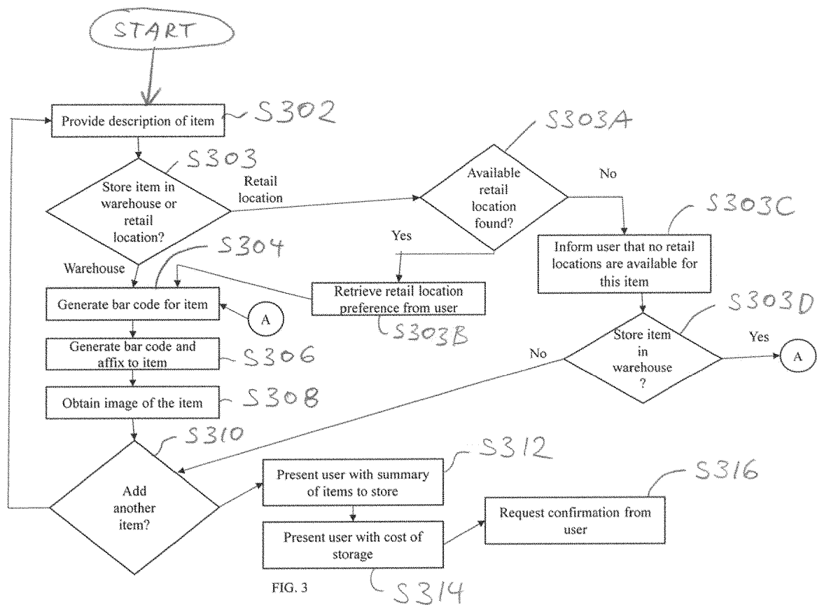

When the user requests to place items in storage, (Step S212), the user may be requested to provide information concerning each item. The steps following Step S212 are described with reference to FIG. 3.

Referring to FIG. 3, the user may provide a description an item (Step S302) (e.g., what the item is, the size of the item, the weight of the item, etc.), and the user can also include instructions on how to handle the item(s) (e.g., handle with care, fragile, etc.). In addition, the user may indicate what type of a storage location is desired (e.g., a dry and warm storage chamber).

The user may be prompted to indicate whether the item should be stored in a warehouse (e.g., long term storage) or in a retail location for short-term storage and/or ease of accessibility. (Step S303).

When the user indicates a preference for retail location storage, the method includes determining whether any suitable retail locations can be found for storing the item. (Step S303A). This includes considering the size and weight of the item and any special requests for storage, for example, heated or cooled storage conditions, etc.

When a suitable retail location is found, the user is asked to select one of the retail locations based on the user's location preference. (Step S303B). When no suitable retail location(s) is/are found, the method includes informing the user that no retail locations are available for this item, (Step S303C), and querying the user whether the user desires to store the item in a warehouse instead (Step S303D).

When the user agrees to store the item in a warehouse, the method proceeds with Step S304. When the user does not wish to store the item in a warehouse, the method may skip to Step S310, which is described in detail below.

When the user indicates in Step S303 that the item should be stored in a warehouse, the method proceeds with Step S304.

The method of FIG. 3 may include generating a one-dimensional (1D) or two-dimensional (2D) bar code for the item (Step S304). The 1D bar code may be, for example, linear bar code, and a 2D bar code may be, for example, a QR bar code. Step S302 may also include associating the generated bar code with the item, the item's location, and the item's status (e.g., in transit, waiting to be delivered, placed in storage, etc.).

The method may include printing the generated bar code, affixing the bar code to the item, and scanning the bar code in order to determine the item's location and status (Step S306). Upon scanning the bar code, the user may be requested to provide an image of the item (Step S308). The image may be used to verify that the item is in fact what the user claims it to be.

Upon receiving the image, the method includes querying whether the user has more items that need to be placed in storage (Step S310). If the user indicates yes, the method loops back to Step S302 for the additional item. This process may be repeated for each item that the user needs to place in storage.

The method of FIG. 3 may also include obtaining from the user information regarding how long each item is expected to remain in storage (or will remain in storage), and whether the item will be stored in a storage area 606 (see FIG. 6) of a particular retail location or in a warehouse.

When the user indicates that there are no additional items for storage, a summary of each item requested to stored can be provided. (Step S312).

The user may be presented with a fee for each item that he/she requested to store (Step S314). The storage cost may be based per-item, or per container 604 (see FIG. 6), and may be different for retail location storage and for warehouse storage. Then, the user may be prompted to confirm the request for storage, agrees to the storage fee(s), agrees to terms and conditions for utilizing the storage system, etc. (S316). The method then will create an open order which can be transmitted to the workstation 102 and/or system database 104 for processing as will be described further below.

A user can interact with any one of the kiosks 106 and can use a personal device 112 to connect to the workstation 102 in order to perform the method steps of FIGS. 2 and 3. Alternatively, or in addition, a user can interact with the system 100 by connecting thereto through a web-based browser or app on the user's device 112.

In an embodiment, the software on the kiosk 106 and user application/web browser simply provides an appropriate user interface for interacting with functionality provided on the workstation. The kiosk system may include additional local functionality to manage local devices used in the method, such as printing and dispensing code tags and capturing item images.

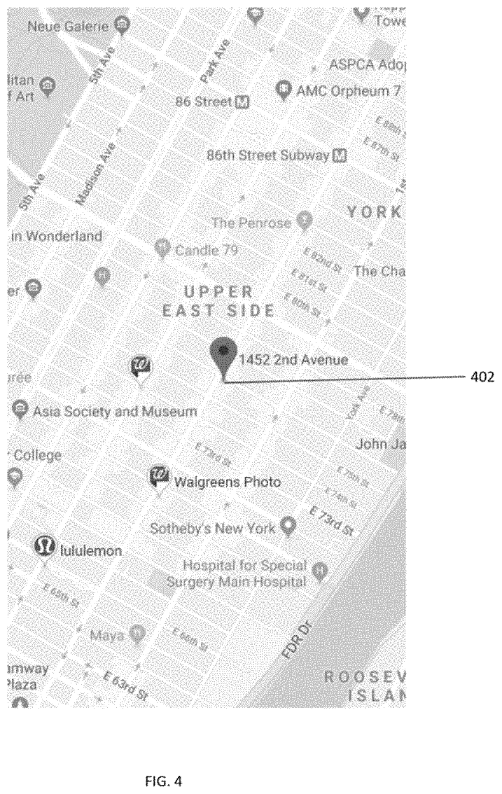

The kiosks 106 may be dispersed in convenient and easily accessible locations. The kiosks 106 can also be included in retail locations as shown in FIG. 4.

The kiosks 106, whether arranged in retail locations or as stand-alone units, may be distributed, for example, in shopping centers, individual business locations, building lobbies (whether residential or non-residential buildings), post offices, parking garages, etc.

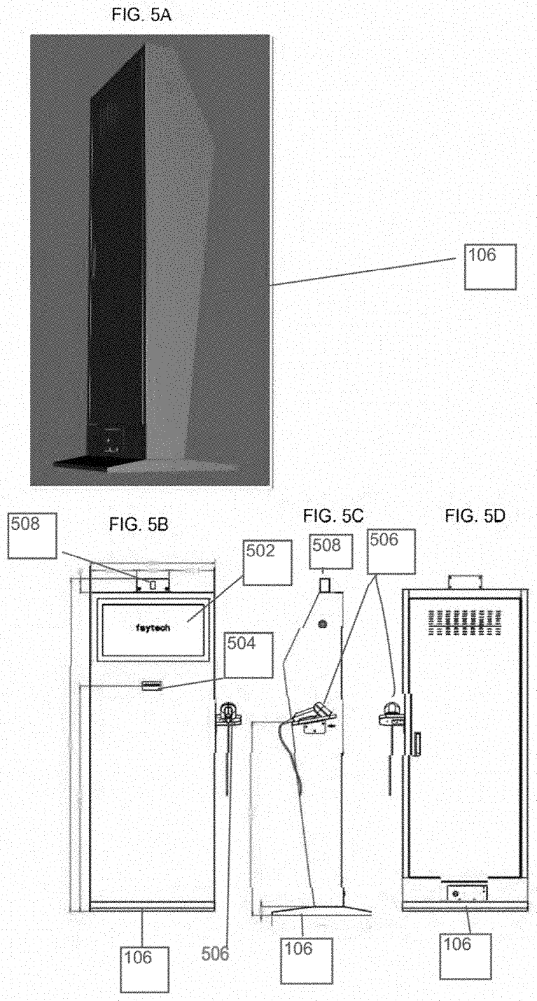

FIGS. 5A-5D illustrate an exemplary kiosk 106. Referring to FIGS. 5A-5D, each kiosk 106 may include an internal computer (not shown), a display panel 502, a printer 504, a scanner 506 and a camera 508. Each kiosk 106 may also include a keyboard (not shown). The display panel 502 may be a touch screen display. The keyboard can be used for receiving the user's description of the item(s) to be stored and/or retrieved from storage. The printer 504 may be configured to print the 1D or 2D bar code labels for each article/item that a user seeks to place in storage. Printed codes can be affixed to the item and/or a storage container into which the item is placed. Multiple copies of a single code label can be provided to allow labeling of both item and a container (in which the item is placed) separately. The scanner 506 can be used to scan the bar codes and the camera 508 can be used. The camera 508 may be used to obtain images of the item(s) that a user requests to store. Camera 508 may be fully adjustable such that its orientation direction can be selectively moved to face an item and/or barcode, and can be configured to provide different magnification levels. Camera 508 can be used to capture images and/or video.

Each kiosk 106 may be in communication with the workstation 102, such as over one or more of LAN, WAN, the Internet, or other wired or wireless network. Thus, a user who walks into any one of the retail locations (see FIG. 4) may utilize an available kiosk 201 to access the system for storing items into a storage facility and for retrieving the user's item from the storage facility.

FIG. 5E is a perspective view of a kiosk 106A according to an embodiment of the present disclosure. Referring to FIG. 5E, kiosk 106A may include an internal computer (not shown), a display panel 502A, a printer 504A, a scanner 506A and a camera 508A. Kiosk 106A may also include a keyboard (not shown). The component of kiosk 106A may be configured similarly to their corresponding counterparts of kiosk 106. Thus, a repetitive description thereof will be omitted for brevity purpose.

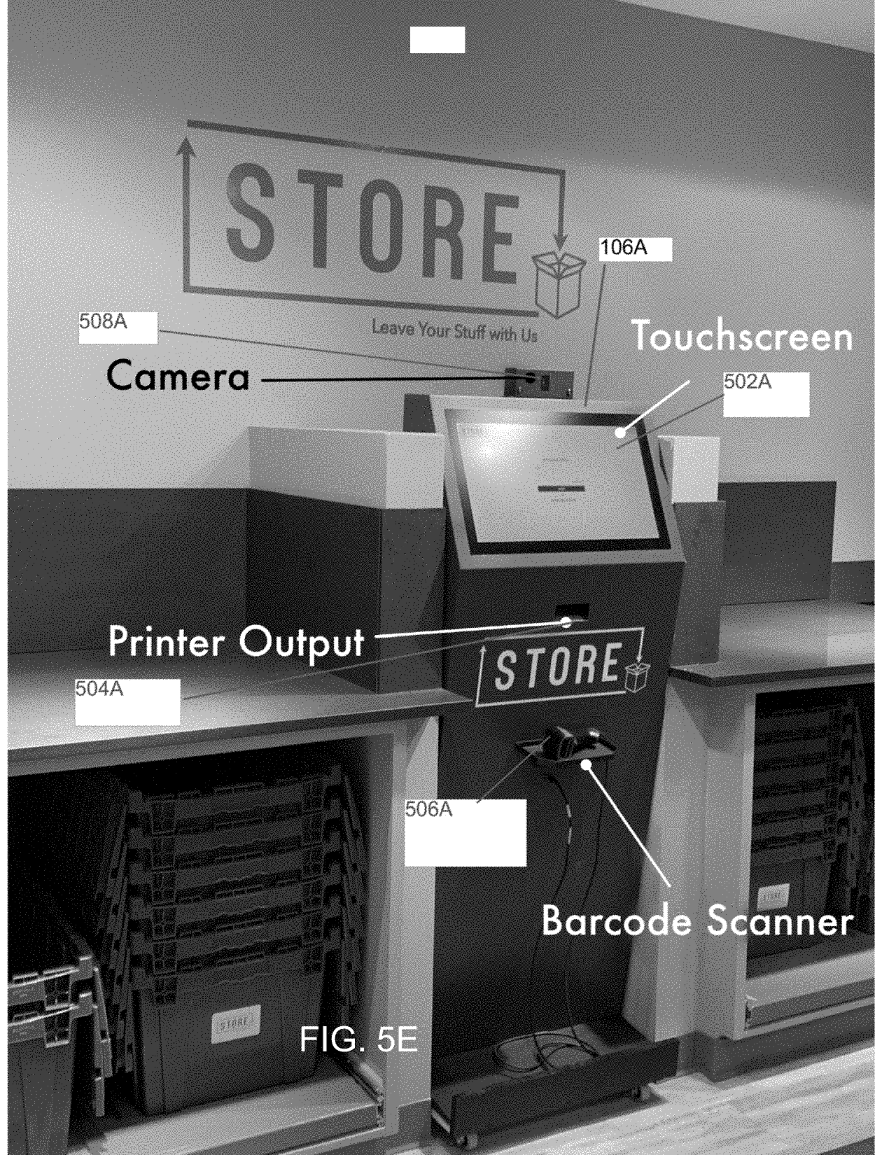

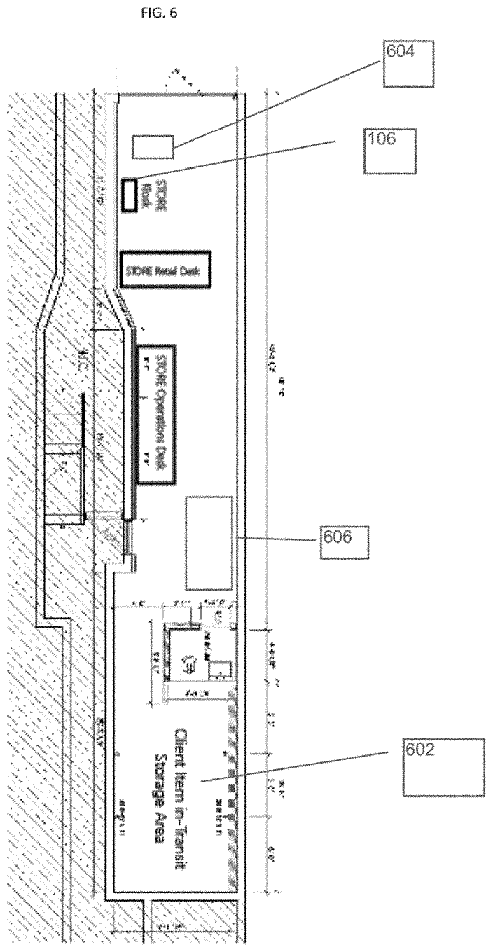

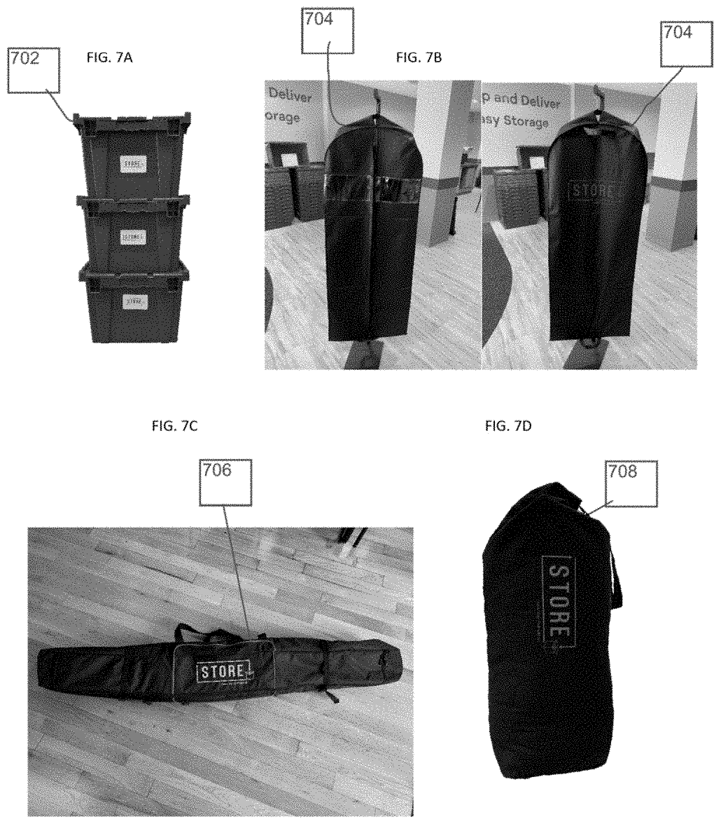

FIG. 6 is a plan view of an exemplary retail location 402, according to an embodiment of the present disclosure. Each retail location 402 may include one or more kiosks 106, a temporary storage area 602, a plurality of containers 604, and storage area 606. The containers 604 may be, for example, storage bins 702 (see FIG. 7A), garment bags 704 (See FIG. 7B), ski bags 706 (see FIG. 7C), duffel bags 708 (see FIG. 7D), etc.

A user can utilize the containers 604 in order to place his/her item(s) therein for the user's convenience and for ease of transportation and record-keeping purposes. The containers 604 may be standardized in shape, size, etc. When one or more bar codes are affixed to a container 604 (the bar code can be scanned to identify the user (e.g., owner) of the items placed therein, the description of the items, the status of the items, etc. The code can also be used for record keeping purposes such as determining the exact storage location of the container 205 in a warehouse, the location of the warehouse, type of storage location (e.g., refrigerated room, heated room, etc.), date of storage, etc. In addition, the code can be used in tracking track the status and location of each item during the transportation phase, whether into or out of storage.

The storage area 606 can be used for storing items in the retail location premises. The storage area 606 can include, for example, lockers, racks, shelves, small rooms, etc., which users can utilize for storing frequently accessed items. As an example, the storage area 606 can be used to store bikes, golf club, strollers, garment bags, ski bags, etc. The storage area 606 can be secured, for example, it can be locked. Each user's item(s) can be stored in a separate compartment/chamber within the storage area 606. Users wishing to store items in the storage area 606 may be provided with a key or access code to access their items when desired. Alternatively, or in addition, an authorized retail location employee can store and retrieve items from the storage area 606.

Each item stored in the storage area 606 can be tagged with bar codes and photographed prior to storage, similarly to the items that are stored in a warehouse 116. The bar code of each item that is stored and retrieved from the storage area 606 is scanned such that the status of the item can be updated (e.g., to indicate whether the item is stored, retrieved, etc.). The storage area 606 can have different pricing (e.g., higher pricing) than the warehouses 116 per item or per container.

Thus, the storage area 606 provides storage solutions for users who need local storage (e.g., relative to their residence, place of employment, or other location) for items that may need to be accessed/stored and retrieved frequently.

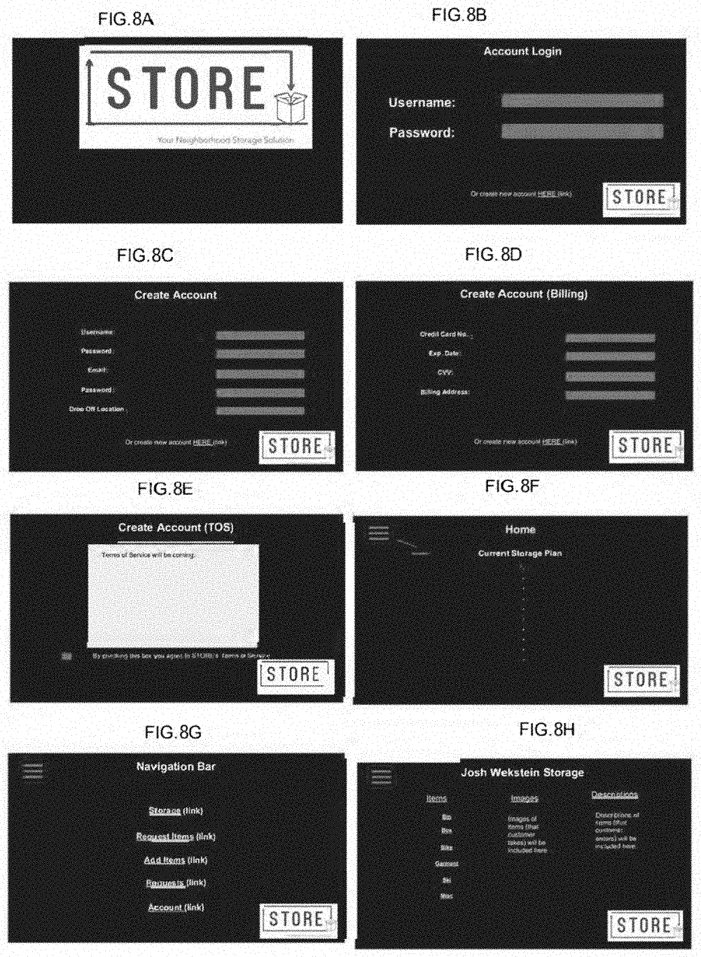

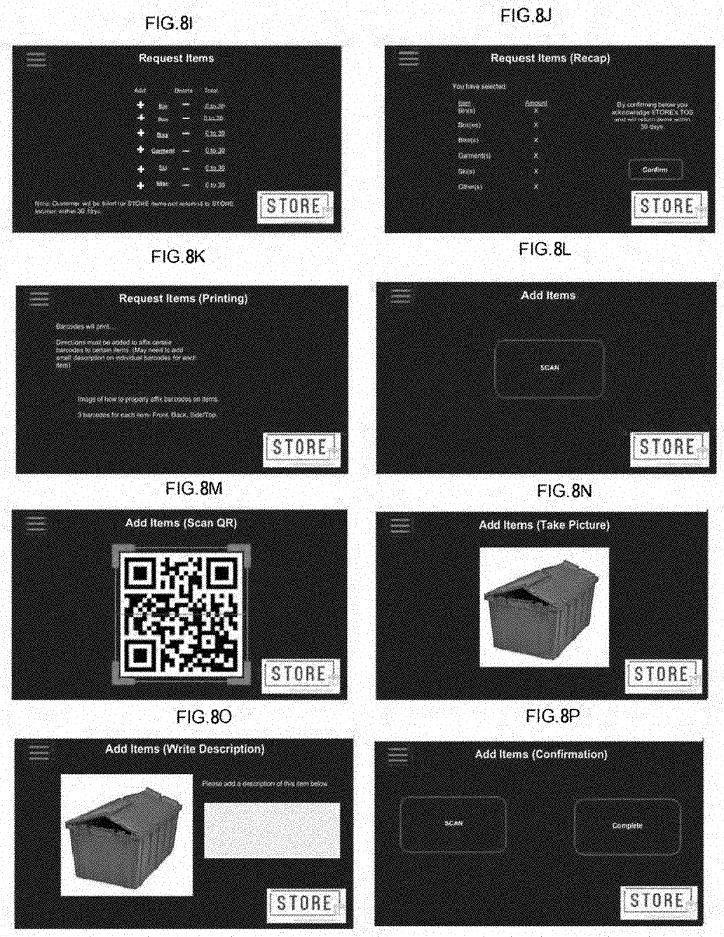

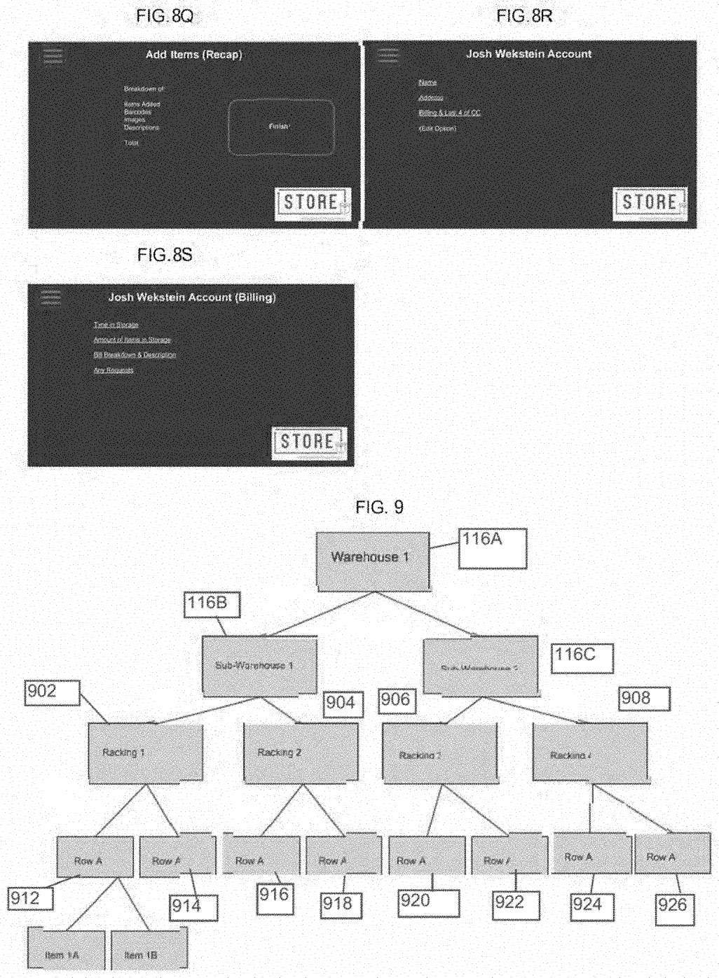

FIGS. 8A-8S illustrate exemplary screen shots displayed on the display panel 502 of a kiosk 106 and or on a display panel of a user device 112 when a user engages with the kiosk 106 or device 112, as the case may be, in order to perform the method steps of FIGS. 2 and 3. FIGS. 8A-8S will be described below when a user engages with a kiosk 106, but the equivalent screens may be displayed on a user's personal device 112.

FIG. 8A illustrates an exemplary welcome screen shot while the kiosk 106 is idle. Upon the user's touch of the display panel 502, the display panel may illustrate an account login page, as shown in FIG. 8B. When a user is not registered, the user may be requested to enter a username, a password, and certain other identifying data as shown in FIG. 8C. FIG. 8D illustrates an exemplary screen shot prompting the user to enter financial information (e.g., a credit card number, a bank account number, the user's billing address, etc.) such that the user can be billed accordingly for storing and/or retrieving items from storage.

FIG. 8E is an exemplary screen shot illustrating a legally binding contract that the user may need to execute in order to utilize the storage method, devices and facilities of the present invention.

FIG. 8F illustrates an exemplary “home page” of the user's account with the user's current storage plan.

FIG. 8G illustrates an exemplary navigation page presenting a plurality of options with for the user to select. For example, the screenshot of FIG. 8F illustrates a link for “storage”, a link for “request items”, a link for “add items,” a link for “requests”, and a link for “account”.

FIG. 8H illustrates an exemplary “storage” screen shot. As illustrated in FIG. 8H, the “storage” screen shot illustrates the items that the user currently has in storage, images for each of the items, and a description for each of the items. As shown in FIG. 8H, the user has a bin, a box, a bike, and a garment in storage.

FIG. 8I illustrates an exemplary “request items” screen shot. Referring to FIG. 8I, the user can request to store items on a per-item basis, and/or on a per-container 604 basis. When opting for a per-item basis, the user can be billed for each individual item that will be placed in storage. When opting for a per-container 604 basis, the user can be billed for each different type of container 604 requested (which can be filled with one or several items).

For each of the items that the user requests to store, the user may utilize the storage bins 702, boxes, the garment bags 704, ski bags 706 and/or duffel bags 708, that are located within the retail location 106, as appropriate, depending on the items that the user needs to store. For items with irregular/unusual shapes, the user may utilize a custom-sized storage container housing the item during the transportation and storage periods. Alternatively, employee(s) of the retail location may assist the user to package the irregular/unusual item.

Even when requesting a per-item storage, all of the user's items can be housed in one or more containers 604 (e.g., a box, a storage bin, a bike bag, a garment bag, a ski bag, etc.), as appropriate, for conveniently inventorying and transporting the items to and from a storage warehouse 116.

FIG. 8J illustrates a recap of all of the items that the user requested to place in storage.

FIG. 8K illustrates a screen shot that indicates that a unique code or codes will be printed for each item that the user requested to store (using printer 504). After printing, the code labels can be affixed to each corresponding item separately.

FIG. 8L is an exemplary screen shot requesting the user to scan each QR code for each respective item that will be placed in storage. The scanner 506 may be used to scan the QR codes.

FIG. 8M is an exemplary screen shot illustrating a QR code scanned by using the scanner 305.

After FIG. 8M, the kiosk 106 may ask the user to take a picture of each item that will be stored. The kiosk may be used to photograph each item for storage by using the camera 508.

FIG. 8N is an exemplary screen shot of an item that the user took a picture by using the camera 508.

FIG. 8O illustrates a prompt box for the user to enter a written description of the photographed item. The user may utilize the keyboard for entering the written description.

FIG. 8P is an exemplary screen shot presenting the user with the option to scan additional items or to complete adding items for storage.

FIG. 8Q is an exemplary screen shot with a recap of the items to be stored. The recap screen shot may itemize each item that will be placed in storage, may illustrate a photograph of each item, may illustrate a QR code associated with each item, and a written description of each item. In addition, FIG. 8Q may illustrate the total amount of money that will be billed to the user for placing the requested items in storage.

FIG. 8Q illustrates a “Finish” button which the user can tap, thereby indicating the user agrees to the charge amount in order to finalize the request for storage.

FIG. 8R illustrates an exemplary account summary screen shot that indicates the account holder name, address and billing information.

FIG. 8S illustrates an exemplary account summary screen shot that indicates the number of items in storage, when each item was placed in storage, itemized bill(s), and all of the requests for storage/retrieval made by the user.

In an embodiment, the operator of the overall system 100 maintains only a small delivery fleet, or even no vehicles. Instead, vehicles that are utilized for picking up the users' items from a retail location and/or for delivering the items back to users can be rented/hired on a need-basis. This reduces the cost of purchasing, operating, maintaining and insuring a fleet of delivery vehicles while still providing users with the flexibility to store and retrieve items from a warehouse when desired.

When the operator of the system 100 maintains a small delivery fleet, the system database 104 may be used to create and store profiles of the users as well as profiles of the drivers which can be tasked with transporting the user's items to and from storage, a list of different vehicles which the drivers can utilize the transport the user's items to and from storage, a list with the profile of each authorized employee (whether one working at a retail location or system administrators), a list of the address and description of each retail location and each kiosk, and a list of warehouses that are available for use or that are currently being utilized to store the users' items.

The profile of each driver may include a driver ID number, the driver's name, home address, contact information, area which the driver can service, preferred working hours, etc. The profile of each driver may also include one or more vehicles which the driver is licensed to operate, and whether the driver owns a vehicle or whether the driver needs to be supplied with a vehicle.

The list of vehicles can include a plurality of entries for different vehicles that can be used to transport the user's items to and from storage. For each vehicle, the entry can indicate the vehicle make, year, model, gross vehicle weight rating, maximum payload capacity, the dimensions of the cargo area of the vehicle, whether the vehicle is available for use, currently in use, out of service, etc.

The list of employee profiles may include the identity of each authorized employee, the employee's title, ID number, the employee's authorized level of access within the computer system, etc.

The list of retail and kiosk 106 locations may include an address entry for each retail location, the machine ID number of each kiosk 106 at each retail location, for the kiosks 106 that are not installed in kiosks, the machine ID and the location of each kiosk 106. a list of the address and description of each retail location and each kiosk, and the features of each kiosk (e.g., a touch screen panel, a scanner, printer, etc.).

The list of warehouses includes a location of each warehouse facility 116 that is available for use and of each warehouse facility which contains users' items stored therein. For each warehouse facility 116, the list may include the type of available storage options (for example, open warehouse floor, refrigerated room, warm and dry room, etc.) the dimensions of each type of room/partition of the warehouse, each room's capacity for certain standardized bins, boxes, garment bags, ski bags, stroller containers, golf club containers, etc. For each chamber of each warehouse location, the list may indicate how much space is available for storage and how much space has been occupied by stored items. In addition, each item barcode may be associated with the location of the chamber that the item is stored such that a complete inventory of where each item is located in each warehouse is available.

FIG. 9 illustrates a representative warehouse hierarchical chart 900 illustrating the relationship between some or all of the warehouses 116. The warehouse hierarchical chart 900 illustrates the relationship between a group of warehouses 116 serving a particular geographical region. Each different geographical region may be served by a different group of warehouses 116.

Referring to FIG. 9, warehouse 116A may be a main or primary storage warehouse facility. Warehouse 116A may be used as a storage facility for receiving deliveries from a group of retail locations serving a particular geographic location, and as a central hub for delivering items back to the retail locations.

Warehouse 116A may have a plurality of different storage chambers suited for items of various sizes and weight. In addition, some of the storage chambers of warehouse 116A may be cooled or heated. The cooled and heated storage chambers may also be provided with humidifiers or dehumidifiers, as may be needed for storing certain items.

As an example, warehouse 116A may include a 10-foot by 10-foot storage unit with a predefined ceiling height. The 10-foot by 10-foot unit may include, for example, racking systems including shelves, rods, containers and other storage apparatuses. The 10-foot by 10-foot unit may also have a locking door for security purposes, for example, a steel roll-up or swing door. Warehouse 116A may have storage chambers with different dimensions. Some of the storage chambers in warehouse 116A ma include garment racks, storage shelves, etc.

Warehouse 116A may, for example, be located closer or otherwise be in a convenient location for sending and receiving user's items from retail locations in a predefined geographical region.

Warehouses 116B and 116C may be warehouse facilities located within a certain distance from warehouse 116A. Warehouses 116B and 116C may also be referred to as secondary warehouses, or deep storage warehouses. Warehouses 116B and 116C may also have different storage chambers with different climate control features. For example, with reference to FIG. 9, warehouses 116B and 116C may include storage chambers with racking 902 to 908, rows 912 to 926, etc. The garment rackings 902 to 908 may be, for example, garment racks.

Warehouses 116B and 116C may be used in conjunction with warehouse 116A for storing users' items that will remain in storage for a long time, or at least longer than some of the other items. By using warehouse 116A for storing items that will be stored for a relatively short period of time, the system of the present invention optimizes storage efficiency.

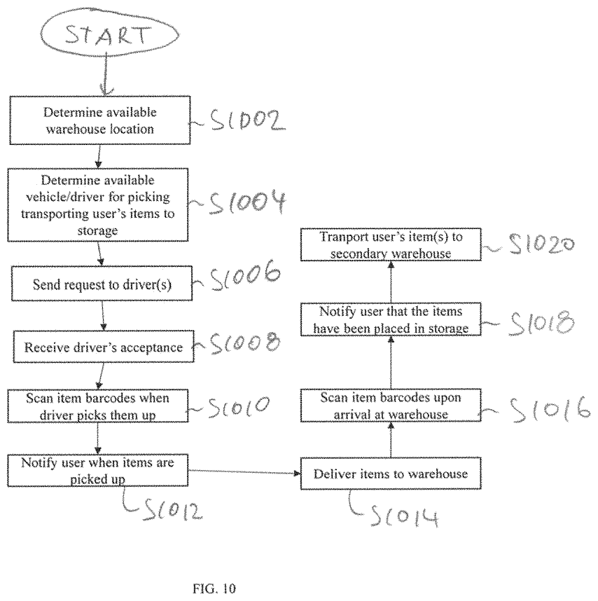

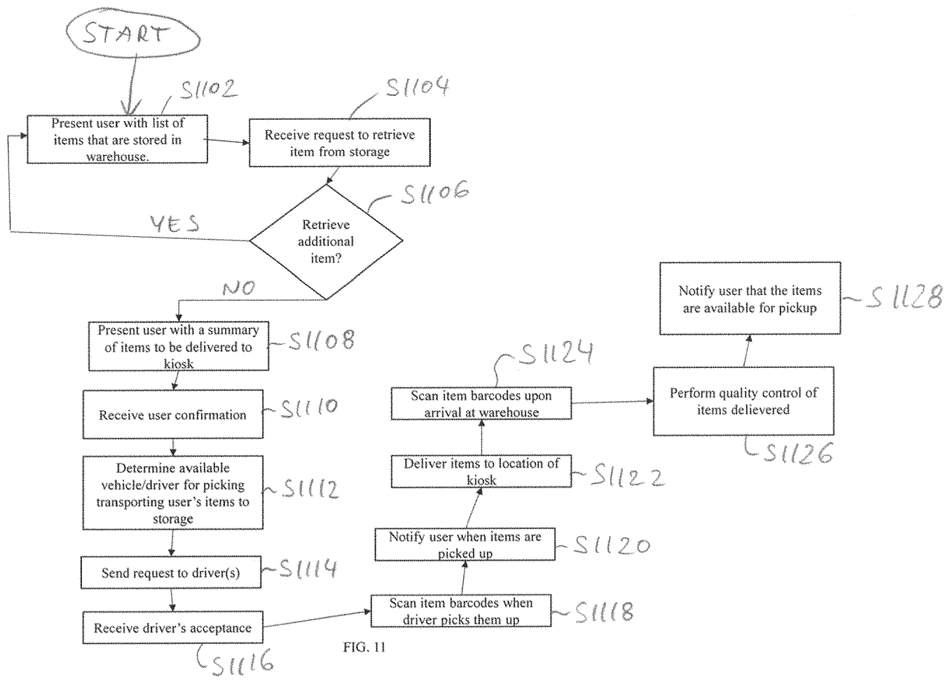

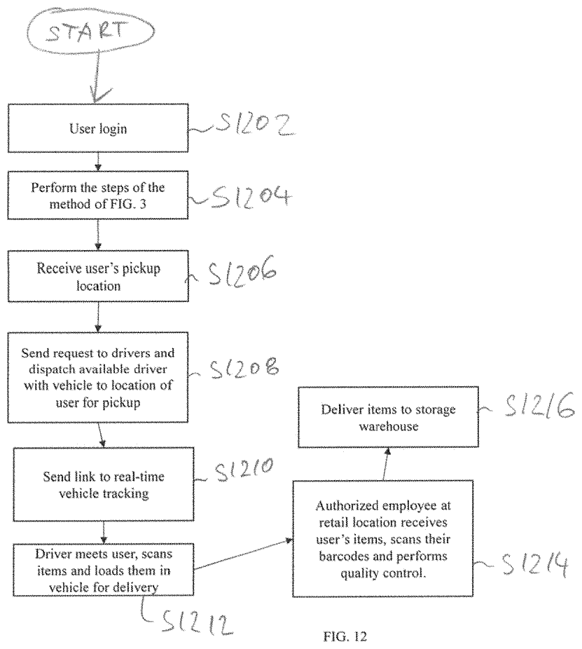

FIG. 10 illustrates a method of matching a pickup request from a kiosk 106 for delivery to a warehouse 116 according to an embodiment of the present disclosure.

Referring to FIG. 10, after the workstation 102 receives a request to transport items into a storage facility (see FIG. 3, step S316), the method includes determining a suitable storage location for the user's items. This is includes determining, for example, the location of the primary storage warehouse 116A that serves a particular geographical location (e.g., where the user is located) and/or the location of a kiosk (S1002). For example, Step S1002 includes determining the location of the primary warehouse 116A serving the user's geographic location.

In addition, the method includes matching an available driver with an available vehicle for transporting the user's items to and from storage. (Step S1004). This can be done by using conventional methods for maximizing travel efficiency, for example, by combining multiple items into the smallest vehicle than can fit all of the packages, by packing multiple users' items into a same vehicle, by utilizing a truck instead of multiple smaller vehicles, etc. This can be done when using employed drivers and when using ride-share drivers through the network 114.

When utilizing employed driver, after determining available driver(s), suitable vehicles and available storage warehouse(s), the method includes alert to the driver device 110 of each available driver with a request to transport the user's items. (Step S1006). The alert includes pickup location, the drop off destination, and a description size/weight (and any special handling notes) for each item. Once one a driver accepts the request (S1008), the system may assign the particular trip to the driver, and withdraw the request from the other available drivers.

When the operator of the system 100 does not own a delivery fleet. the workstation 102 may be loaded with an app for connecting to one or more ride-share networks 114. For example, the workstation 102 may be configured to use local taxi cabs, local UBER/LYFT vehicles, etc. The app of the workstation 102 may be configured to maximize the trip the same way as when using in-house drivers and vehicles. In other words, the app may be configured to select available ride-share vehicles based on their capacity, availability, price quote, etc., for a particular trip. In addition, the app would be configured to select the smallest available vehicle or a larger vehicle instead of several smaller ones for the same trip.

Since the system of the present invention can utilize employed drivers and/or ride-share networks 114, the users are spared the inconvenience of dealing with several different parties for their storage needs, and the cost savings can be passed on to the users while still being profitable.

The method may include scanning the items upon loading them in the vehicle when the driver arrives to the pickup location, (Step S1010), and notifying the users that the items have been picked up by the driver. (Step S1012). This may include sending a text message or email to the user. The items may then be delivered to the warehouse (Step S1014), and scanned at the at the warehouse upon arrival (Step S1016). The user may then be notified that the items have been delivered to a suitable storage warehouse (Step S1018).

Items that will remain in storage for a long time period (e.g., as indicated by the user) may be delivered to any one of the secondary storage warehouses 116B and 116C in order to free space for items with short/shorter storage term in the primary warehouse 116A. (Step S1020). This increases the efficiency of use of the storage space in the primary warehouse 116A.

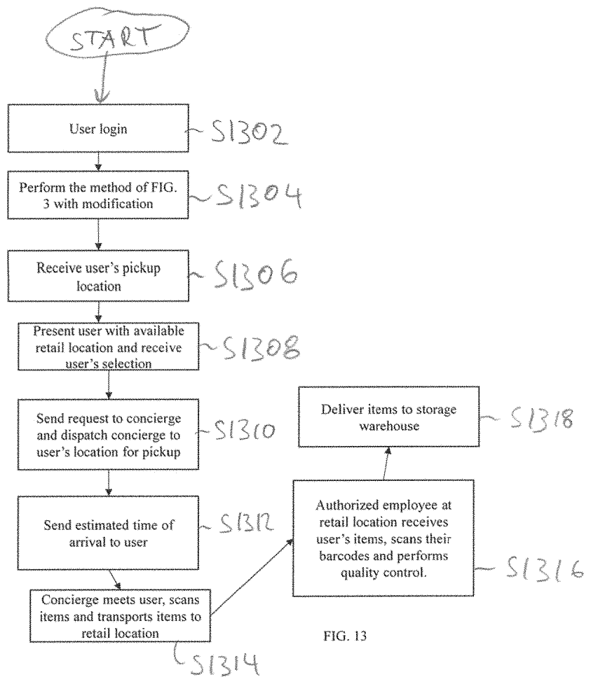

FIG. 11 illustrates a method of retrieving a user's items from a warehouse for delivery to a kiosk 106 according to an embodiment of the present disclosure. Referring to FIG. 11, after the workstation 102 receives a request to retrieve items from the storage facility (see FIG. 2, step S214), the method includes presenting the user with a list of items that are available for retrieval from storage. (Step S1102).

Referring to FIG. 11, a user requests to retrieve a particular item from storage. (Step S1104).

Step S1106 includes querying the user whether he/she would like to retrieve another item from storage. When the user indicates yes, the method may loop to Step S1102. When the user indicates no, the method includes presenting the user with a summary of items to be delivered to the kiosk. (Step S1108). The items may be delivered to the same kiosk 106 that the user is engaging, or into another kiosk 106, depending on user preference.

When the user confirms the kiosk delivery address and the items to be delivered, (Step S1110), the method may include determining and available vehicle and driver for picking up the user's items from storage and delivering them to the pickup kiosk location (which may be a retail location). (Step S1112).

Step S1112 includes determining whether the item(s) are located in a primary and/or secondary storage warehouse. When at least one item is stored in a secondary warehouse, step S1112 may include sending a request to available drivers for picking up the item(s) from the secondary warehouse and transporting the item(s) to the primary warehouse 116. All of the user's items may then be delivered to a retail location from the primary warehouse. Alternatively, or in addition, the user's item(s) may be delivered to the retail location directly from the secondary warehouse.

The selection of driver and vehicle may be performed as described above, whether for an in-house fleet or drivers or through the ride-share network 114.

Step S1114 may include sending the request to the drivers (S1114) and receiving an acceptance from one of the drivers. (Step S1116). The driver may scan the barcodes of each item from the storage facility such that the status of the items can be updated to “in transit”. (Step S1118). The user may also be notified via email or text message when the items are picked up by the driver. (Step S1120). The driver may deliver the user's items to the location of the kiosk (or retail location where the kiosk is disposed) (Step S1122) such that an authorized employee of the operator of system 100 can scan the item barcodes when the driver drops off the items. (Step S124).

Step S1126 includes performing a quality control of each item received at the retail location in order to ensure that the correct items were indeed delivered. This may be done by scanning the bar codes of each item in order to verify the identity of the owner/user and the description of the item. Step S1128 includes notifying the user that the items are available for pickup at the retail location.

Referring back to FIG. 1, each employee may scan the item barcodes by using the employee device. Each employee device may include, for example, a bar code scanner. Each driver may also scan the item barcodes by using the driver devices 110. Thus, the location, status, destination ad description of each item can be updated in real-time, and the user can be notified accordingly.

System 100 can also be used to save the user's trip to and from a kiosk 106 altogether. As described above, users can interact with system 100 through the internet by using their personal devices 112.

FIG. 12 illustrates a method for delivering a user's items from the user's indicated address to a retail location with a kiosk, according to an embodiment of the present disclosure. The method of FIG. 12 contemplates the use of an automobile for transporting the user's items. Prior to requesting a pickup of items, the user would log in by using his/her device 112, as described with reference to FIG. 2. (Step S1202). Then the user would perform the method steps of FIG. 3, similarly to when interacting with a kiosk 106. (Step S1204). When performing the method steps of FIG. 3 at home, the user is presumed to have a printer for generating the bar codes, and a camera for obtaining and uploading (e.g., to the workstation 102) an image of each barcode and an image of each item. The user would then affix the respective bar code to each item.

Step S1206 includes receiving the user's pickup location. Step S1208 includes presenting the user with at least one available local retail store with a kiosk 106 and receiving from the user a selection of which retail store the uses wishes to utilize for processing his/her items. The user's items will be delivered to the selected retail store for further processing/quality control by an authorized employee.

Then, a request would be sent to available drivers (whether in-house or via the ride-share network 114) to pick up the user's items for delivery to the retail location. This can be done as described above for FIG. 10. (Step S1208). When using a driver obtained through a ride-share network 114, the user may be provided with a URL or other type of link to a real-time location of the pickup vehicle together with the estimated time of arrival. (Step S1210).

Step S1212 includes the driver arriving at the user's pickup location, meeting the user, scanning each item, and loading them in the vehicle for delivery. Upon delivery at the user's designated retail location, an authorized employee would scan each of the employee's items in order to verify that all of the items have arrived and that the items match their respective descriptions. (Step S1214). Thus, the status of the items can be updated and the user can be notified that the items have arrived safely at the designated retail location.

When quality control passes, the user's items may be placed in the temporary storage area 602 of the designated retail location pending pickup for delivery to a suitable storage location as described with reference to FIG. 10. (Step S1216).

The same method steps described above for delivering the user's items to a retail location such that they can be processed for placement in storage can also be performed when the user requests a delivery of items from the retail location to the user's location (i.e., after the user's items are retrieved from the warehouse in response to the user's request and are waiting/available for pickup at the retail location designated by the user. In this case, upon arrival of the items from the storage warehouse, an authorized employee would perform a quality control test in order to determine that all of the user's requested items were safely retrieved from storage.

Each authorized employee (whether at the retail locations or elsewhere) may access the workstation 102 in order to monitor some/all of the active pickup, delivery, storage and retrieval orders, as well as the location and status of each item of each user that is currently in storage. Different users may be provided with different access privileges depending on their job duties.

The option for pickup and delivery of the items to and from a user's location (e.g., home) immensely facilitates the storage process for users who do not have the time or means to transport the items between their location and a nearby retail location. Thus, the pickup and delivery options, together with the ability to store and retrieve individual items into a storage facility without having to coordinate separately with drivers and warehouse owners offer unparalleled freedom in storage solutions.

FIG. 13 illustrates a method for delivering items from an indicated address to a retail location according to an embodiment of the present disclosure. The method of FIG. 13 contemplates utilizing a human (e.g., concierge) for carrying the user's item(s) from the user's address to a retail location. The concierge may be dispatched, for example, on foot, on a bicycle (whether electric or human-powered), on a scooter (electric or human-powered), etc. in order to pick up and deliver a user's item(s) to a retail location. The concierge may utilize public transportation means such as the subway (or train(s)), busses, etc., when available. The concierge may be supplied with a storage bin, box, garment bag, etc., for transporting the user's item(s). The concierge can be employed in-house, or can be sourced via a delivery network. When the concierge is employed in-house, the concierge may be provided with an employee device 108 for receiving users' pickup/delivery requests.

Prior to requesting a pickup of items, the user would log in by using his/her device 112, as described with reference to FIG. 2. (Step S1302). Then the user would perform the method steps of FIG. 3, similarly to when interacting with a kiosk 106. (Step S1304).

However, the method of FIG. 13 includes adding a step to the method of FIG. 3. Since the concierge is transporting the user's item(s) on foot or via a bicycle, scooter, etc., the concierge's carrying capacity is limited. Thus, when requesting a concierge pickup, the method of FIG. 13 may include determining whether each one of the user's item(s) can be transported by the concierge. For example, the dimensions and weights of each item may be checked against a predefined weight limit and size limit that the concierge can carry. When the size or weight of a particular item exceeds the limit, the user can be notified that the particular item cannot be delivered via the concierge, and the user may be provided the option to request a delivery by using an automobile instead, as described with reference to FIG. 12.

When one or more items meet the concierge weight and size limit, the method including receiving user's pickup location. (Step S1306).

The method may include presenting the user with at least one retail location for processing the user's items based on the spatial proximity between the user's pickup location and available retail location, and receiving the user's selection as to which retail location the user wishes to utilize. (Step S1308).

Step S1310 includes sending a request to available concierge, whether in-house or through the delivery network 118.

Step S1312 includes sending a notification with the estimated time of arrival to the user based on the route to the user's location and the transportation means of the concierge.

In Step S1314, the concierge meets the user, picks up the items, scans their bar codes, and transports the items to the retail location selected by the user.

Step S1316 includes scanning the items for quality control upon arrival at the retail location and notifying the user that the items were successfully delivered to the retail location.

Step S1316 includes delivering the items to the warehouse location as described above.

The same method steps described above for using a concierge to deliver the user's items to a retail location can also be performed when the user requests a delivery of items from the retail location to the user's location (i.e., after the user's items are retrieved from the warehouse in response to the user's request and are waiting/available for pickup at the retail location designated by the user.

While the present invention has been particularly shown and described with reference to exemplary embodiments thereof, it will be apparent to those of ordinary skill in the art that various changes in form and detail may be made therein without departing from the spirit and scope of the present invention.

What is claimed is:

1. A method for depositing items into a storage facility, the method comprising:
receiving a request for storing a first item;
requesting information be provided describing the first item;
receiving the information;
determining a vehicle type that is adapted to transport the first item based on the information received;
determining a first location where the first item is available for pickup;
determining a storage facility that can be used for storing the first item, wherein the storage facility is associated with a physical address which corresponds to a second location; and
dispatching a vehicle that matches the determined vehicle type to the first location with instructions for picking up the first item and delivering the first item to the second location such that the first item can be stored at the storage facility.

2. The method of claim 1, wherein the information descriptive of the first item includes at least one of the size and weight of the first item.

3. The method of claim 1, wherein the first location corresponds to a location of a kiosk or to a location provided by a user.

4. The method of claim 1, further comprising generating a QR code for the first item and associating the generated QR code with the first item for record-keeping purposes.

5. The method of claim 1, further comprising obtaining image data illustrating the first item for verification purposes.

6. The method of claim 1, further comprising prompting a user whether the user has a second item that needs to be deposited into the storage facility in addition to the first item.

7. The method of claim 6, wherein, when the user indicates that the user has a second item to deposit, the method further includes:
requesting the user to provide information that describes the second item; and
receiving the information that is descriptive of the second item from the user,
wherein, when the user provides the information that is descriptive of the second item, the determination of the vehicle type includes taking into consideration the information that is descriptive of the first and second items such that the vehicle type can fit and transport both the first and second items.

8. A storage system comprising:
a processor; and
a non-transitory, tangible, program storage medium, readable by the storage system, embodying a program of instructions executable by the processor to perform method steps for depositing a user's items into a storage facility, the method comprising;
receiving the user's request for storing a first item;
requesting the user to provide information descriptive of the first item;
receiving the information from the user;
determining a vehicle type that is adapted to transport the first item based on the information received from the user;
determining a first location where the first item is available for pickup;
determining a storage facility for storing the first item, wherein the storage facility is associated with a physical address which corresponds to a second location; and
dispatching a vehicle that matches the determined vehicle type to the first location with instructions for picking up the first item and delivering the first item to the second location such that the first item can be stored at the storage facility.

9. The storage system of claim 8, further comprising at least one computer that is located at a kiosk for providing the user with access to the program of instructions with method steps for depositing the user's items into the storage facility.

10. The storage system of claim 9, wherein the kiosk is located at a publically accessible location.

11. The storage system of claim 10, wherein the publically accessible location is a residential building, a parking garage, a postal office or a retail business.

12. The storage system of claim 9, further comprising at least one of a printer and a camera communicatively coupled to the at least one computer, wherein the printer is configured to print a bar code or QR that is associated with the with the first item, and wherein the camera is configured to obtain an image of the first item together with the bar code or the QR that is associated with the first item, or an image of the bar code or QR without the first item.

13. The storage system of claim 9, wherein the first location corresponds to a location of the kiosk.

14. The storage system of claim 9, wherein the kiosk is supplied with at least one of a bin, a garment bag, a ski bag and a bike bag for storing the first item therein.

15. The storage system of claim 8, wherein the program of instructions with method steps for depositing the user's items into the storage facility is accessible to the user through the internet.

16. The storage system of claim 8, wherein the program of instructions executable by the processor is further configured to dispatch the vehicle with a driver to a third location for picking up the first item a the third location such that the first item can be delivered to the second location.

17. The storage system of claim 9, wherein the program of instructions executable by the processor is further configured to perform method steps for retrieving the user's items from the storage facility, the method for retrieving the user's items from the storage facility comprising:
receiving the user's request for retrieving the first item from storage; and
dispatching a vehicle to the second location with instructions to pick up the first item and to deliver the first item to the first location, wherein the dispatched vehicle is of a type that has been determined to be adapted to transport the first item.

18. The storage system of claim 8, wherein the information descriptive of the first item includes at least one of the size and weight of the first item.
